(19) United States
(12) Patent Application Publication
(10) Pub. No.: US 2018/0173938 A1
(43) Pub. Date: Jun. 21, 2018

(54) FLAW DETECTION AND CORRECTION IN DIGITAL IMAGES

(71) Applicant: Intel Corporation, Santa Clara, CA (US)

(72) Inventor: SIRUI YANG, Beijing 11 (CN)

(73) Assignee: Intel Corporation, Santa Clara, CA (US)

(21) Appl. No.: 15/577,057

(22) PCT Filed: Jun. 26, 2015
(86) PCT No.: PCT/CN2015/000466

§ 371 Date: Nov. 27, 2017

(51) Int. Cl. G06K 9/00; G06T 7/00; G06T 5/00

(52) U.S. Cl. CPC G06K 9/00281; G06K 9/00288; G06T 2207/30201; G06T 5/005; G06T 7/0002

(57) ABSTRACT

At times, subjects having one or more flawed features, such as eyes closed or a frown, may appear in images acquired using an image acquisition device. An image editing circuit removes such flawed features by identifying the flawed features in the first image and uniquely identifying the subject having the flowed features. The image editing circuit autonomously identifies historical images in which the subject appears and in which the subject has an unflawed feature corresponding to the flawed feature in the first image. The image editing circuit autonomously extracts the unflawed feature from the historical image and replaces the flawed feature in the first image with the unflawed feature.

### TECHNICAL FIELD

The present disclosure relates to digital image processing.

### BACKGROUND

Nearly all modern electronic devices have either a native ability or a peripheral ability to capture digital images. At times, unintentional flaws may appear in digital images acquired by an electronic device. For example, one subject in a group of subjects may frown, squint, or blink while every other subject in the group is smiling with eyes wide open. While it is possible to “touch-up” such a defect using a stock smile or eyes acquired from another image, such touch-ups are often quite evident due to the unnatural appearance of such generic features. This is particularly true when the party viewing the image has an intimate knowledge of the subject's features.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system capable of detecting and correcting flaws in digital images, in accordance with at least one embodiment of the present disclosure;

FIG. 2 illustrates a block diagram of an example system capable of detecting and correcting flaws in digital images, in accordance with at least one embodiment of the present disclosure;

FIG. 3 illustrates a high-level flow diagram of an example method of detecting and correcting flaws in a digital image, in accordance with at least one embodiment of the present disclosure;

FIG. 4 illustrates a high-level flow diagram of an example method of receiving user input for detecting flaws in a digital image, in accordance with at least one embodiment of the present disclosure;

FIG. 5 illustrates a high-level flow diagram of an example method of receiving user confirmation in detecting and correcting flaws in a digital image, in accordance with at least one embodiment of the present disclosure;

FIG. 6 illustrates a high-level flow diagram of an example method of scaling a historical image such that a replacement feature selected from the image is of a size of a corresponding flawed feature in a digital image, in accordance with at least one embodiment of the present disclosure;

FIG. 7 illustrates a high-level flow diagram of an example method of adjusting image parameters such that a replacement feature selected from the image is of similar image parameters to a corresponding flawed feature in a digital image, in accordance with at least one embodiment of the present disclosure; and

FIG. 8 illustrates a high-level flow diagram of an example method of adjusting subject pose such that a replacement feature selected from the image is similar in pose to a flawed feature in a digital image, in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

At times, digital images may contain one or more objects having flaws or similar undesirable elements. These feature flaws often occur with animate objects such as animals and human beings who may, at times, behave in an unpredictable manner. For example, a human subject may yawn or blink at the instant a digital photograph is taken. While the instant accessibility to digital images frequently makes it possible to retake an image, at times spontaneous images are difficult or impossible to reshoot or lack the spontaneity of the original image. In such instances, fixing the flaws in the original image becomes the preferred option.

Current techniques for fixing such flaws often involve costly and frequently complex image editing software such as PHOTOSHOP® (Adobe Systems, Inc., San Jose, Calif.) or APERTURE® (Apple, Inc., Cupertino, Calif.). The expertise required to properly retouch images using such software is very often outside the limits of casual photographers. Some photo beautification software, such as that available through INSTAGRAM® (Facebook, Inc., Menlo Park, Calif.) may alter or adjust all or part of a facial zone of a subject with effect filters, however such filters, at best, cover or hide feature (e.g., facial) flaws and typically do not correct the underlying feature flaw.

Moreover, simply replacing a feature flaw with a “generic” or similar feature obtained from a library or cropped from another random image frequently results in an abnormal appearance of the subject. This is particularly true when the image audience is personally or intimately familiar with the subject (e.g., a spouse or friend of the subject) or is otherwise familiar with the appearance of the subject (e.g., a celebrity). In particular, the use of a second subject's facial features on a first subject may lend an odd or unnatural appearance to the subject.

To address these issues, the systems and methods described herein take advantage of the fact that a particular photographer often has a number of stored historical images of a subject and that by identifying a feature flaw and identifying the subject, a historical image of the subject in which the feature flaw is absent may be used to correct the feature flaw. The use of the same subject improves the appearance of the subject in the final image and lends a more natural appearance to the subject.

The systems and methods described herein may, at times, autonomously identify one or more feature flaws of a subject in a current image. At other times, the systems and methods described herein may accept a manual or user input indicative of one or more feature flaws of a subject appearing in the current image. Using one or more facial recognition techniques, the systems and methods described herein will identify the subject containing the flawed feature and will search one or more locations (e.g., the local device, a remote device, cloud storage, or similar) to locate one or more digital images in which the subject appears. Once a number of historical images of the subject are identified, the systems and methods described herein select an historical image in which the subject appears in the closest size, pose, and image parameters to the current image and in which the subject appears with a corresponding unflawed feature. The systems and methods described herein then extract or otherwise crop at least a portion of the unflawed feature from the subject in the historical image and replace the flawed feature in the current image with the unflawed feature extracted or otherwise cropped from the historical image.

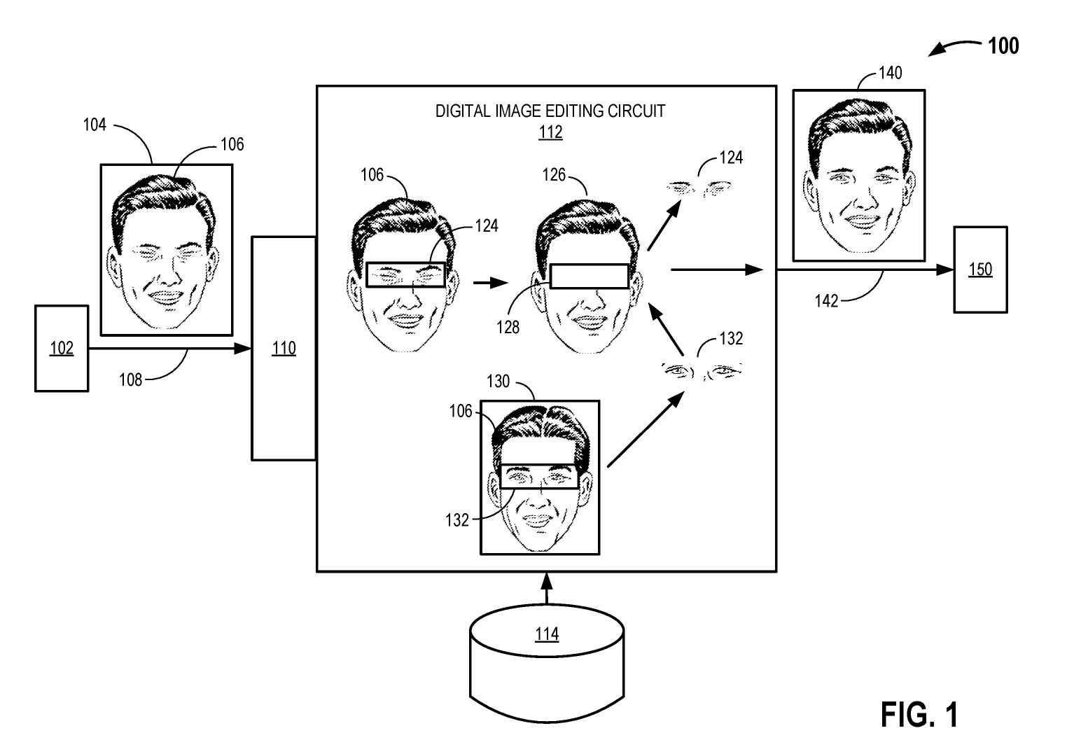

FIG. 1 illustrates an example system 100 capable of detecting and correcting flaws in digital images, in accordance with at least one embodiment of the present disclosure. An image acquisition device 102 generates a first image 104 that contains a subject 106. At times, one or more features of the subject 106 in the first image 104 may contain flaws. For example, as depicted in FIG. 1, the subject's eyes (i.e., the feature) are closed (i.e., the flaw). The first image is received at an interface 110 that is communicatively coupled to a circuit executing one or more machine-readable instruction sets that cause the circuit to function as a particular and specialized image editing circuit 112. The image editing circuit 112 may autonomously identify the flawed feature 124 of the subject 106 included in the first image 104. The image editing circuit 112 may autonomously uniquely identify the subject 106 included in the image 104. For example, the image editing circuit may use one or more facial recognition algorithms to identify the subject 106 included in the first image 104. The image editing circuit 112 may search one or more communicatively coupled storage devices 114 for one or more historical images 130 that includes the subject 106. The image editing circuit 112 may identify a historical image 130 that includes the subject 106 and in which the subject 106 appears with a corresponding unflawed feature 132. The image editing circuit 112 may autonomously replace, in the first image 106, the flawed feature 124 with the unflawed feature 132 to provide a second image 140 that includes the subject 106 and an unflawed feature. The image editing circuit 112 may communicate the second image to an output device 150, for example an image display device.

The image acquisition device 102 can include any number or combination of systems and devices capable of generating the first image 104. Example image acquisition devices 102 can include, but are not limited to, portable or handheld electronic devices such as a digital camera, a smartphone, a tablet computer, an ultraportable computer, a netbook computer, a wearable computer, portable video devices (e.g., GOPRO®, [GoPro, Inc., San Mateo, Calif.]) and the like. The systems and methods described herein are equally applicable to images acquired using one or more fixed systems, such as one or more surveillance cameras. In embodiments, the image acquisition device 102 may include one or more digital acquisition devices, for example one or more electronic devices that include a fixed or adjustable lens or lens system and any current or future electronic image capture technology including, but not limited to, a charge-coupled device (CCD) image sensor; a complimentary metal-oxide-semiconductor (CMOS) image sensor; and N-type metal-oxide-semiconductor (NMOS, Live MOS) image sensor, or similar.

The image acquisition device 102 communicates the data representative of the first image to the interface 110 via one or more data channels 108. The one or more data channels 108 may include any number or combination of wired or wireless data channels. Example wired data channels include, but are not limited to, one or more internal data busses, a universal serial bus (USB), a Thunderbolt® bus (Intel Corp., Santa Clara, Calif.), an IEEE 1394 bus (“Firewire”), or similar Example wireless data channels 108 can include, but are not limited to, BLUETOOTH®, IEEE 802.11 (“WiFi”); near field communications (“NFC”), and the like. Example wireless data channels 108 can include one or more wireless local area networks, one or more wireless wide area networks, one or more cellular networks, one or more worldwide networks (e.g., the World Wide Web or Internet), or various combinations thereof.

Although depicted as discrete devices in FIG. 1, at times, some or all of the image acquisition device, the interface 110, the digital image editing circuit 112, and the image display device 150 may be included in a single device. For example all of the aforementioned may be incorporated into a smartphone or handheld computer.

The interface 110 can include one or more wireless interfaces, one or more wired interfaces, or any combination thereof. The interface 110 may, at times, include one or more internal interfaces (i.e., an interface disposed at least partially within or in the interior of the image acquisition device 110 or the digital image editing circuit 112). The interface 110 may, at times, include one or more external interfaces (i.e., an interface disposed at least partially on an exterior of the image acquisition device 110 or the digital image editing circuit 112). In embodiments, the data representative of the first image 104 may be autonomously transmitted from the image acquisition device 102 to the digital image editing circuit 112 via the interface 110. In embodiments, the data representative of the first image 104 may be transmitted from the image acquisition device 102 to the digital image editing circuit 112 at the direction of the system user. For example, data representative of the first image 104 may be transmitted upon communicable coupling of the image acquisition device 102 to the digital image editing circuit 112, such as by a USB cable or similar.

The digital image editing circuit 112 can include any number or combination of devices or systems capable of identifying and replacing one or more flawed features 124 of a subject included in the first image 104. In embodiments, the digital image editing circuit 112 can include any number of circuits, and may include, but is not limited to: a controller, a processor, a digital signal processor (DSP), a field programmable gate array (FPGA), an application specific integrated circuit (ASIC), a reduced instruction set computer (RISC), or any similar circuit capable of executing a machine-readable instruction set. The machine-readable instruction set, when executed by the circuit, transforms the circuit by causing the circuit to operate and function as a particular and specialized digital image editing circuit 112 as described herein. The digital image editing circuit 112 transforms the first digital image 104 into the second digital image 140 by detecting and replacing one or more flawed features 124 of a subject included in the first image 104.

The digital image editing circuit 112 may communicably couple to any number of storage devices 114. The storage device 114 may include one or more machine-readable instruction sets that, when executed by a circuit, cause the circuit to provide, operate, and function as the specialized digital image editing circuit 112. The storage device 114 can include any number or combination of systems or devices capable of storing data. The storage device 114 may include any current or future developed data storage technology including, but not limited to, one or more optical storage devices, one or more magnetic storage devices, one or more solid-state electromagnetic storage devices, one or more memristor storage devices, one or more atomic or quantum storage devices, or combinations thereof. In embodiments, the storage device 114 may include data representative of any number of historical images 130. In embodiments, the subject 106 included in the first image may appear in at least a portion of the number of historical images 130 stored by the storage device 114.

In embodiments, the storage device 114 may also include one or more machine-readable instruction sets that, when executed by the digital image editing circuit 112, cause the digital image editing circuit 112 to function as a specialized image recognition device. For example, in some implementations, the digital image editing circuit 112 may function as a facial recognition device able to uniquely identify the subject 106 in the first image 104 and also able to identify the subject 106 in at least some of the historical images 130 contained on the storage device 114.

In embodiments, the storage device 114 may also include one or more machine-readable instruction sets that, when executed by the digital image editing circuit 112, cause the digital image editing circuit 112 to provide advance editing capabilities. An example advanced image editing capability is autonomously or manually adjusting the subject 106 in the historical image 130 to more closely correspond to the size of the subject 106 in the first image 104. Another example advanced image editing capability is autonomously or manually adjusting the pose of the subject 106 in the historical image 130 to more closely correspond to the pose of the subject 106 in the first image 104. Yet another example advanced image editing capability is autonomously or manually adjusting image color or lighting in the historical image 130 to more closely correspond to the color or lighting in the first image 104.

The output device 150 includes any number or combination of systems or devices capable of providing a human perceptible output capable of displaying the second image 140. In implementations, the output device 150 may be wiredly or wirelessly communicably coupled to the digital image editing circuit 112. For example, the output device 150 may be wiredly coupled to the digital image editing circuit 112 via one or more interfaces such as a communications bus. In another example, the output device 150 may include any current of future developed display technology including, but not limited to, a liquid crystal display (LCD); a light emitting diode (LED) display, an organic light emitting diode (OLED) display; a polymer light emitting diode (PLED) display; or similar. In some embodiments, the display device 150 may be disposed proximate the digital image editing circuit 112. For example, the display device 150 may include all or a portion of a user interface on a smartphone or similar portable computing device. In other embodiments, the display device 150 may be disposed distal from the digital image editing circuit 112, for example a display device disposed remote from a server that includes the digital image editing circuit 112.

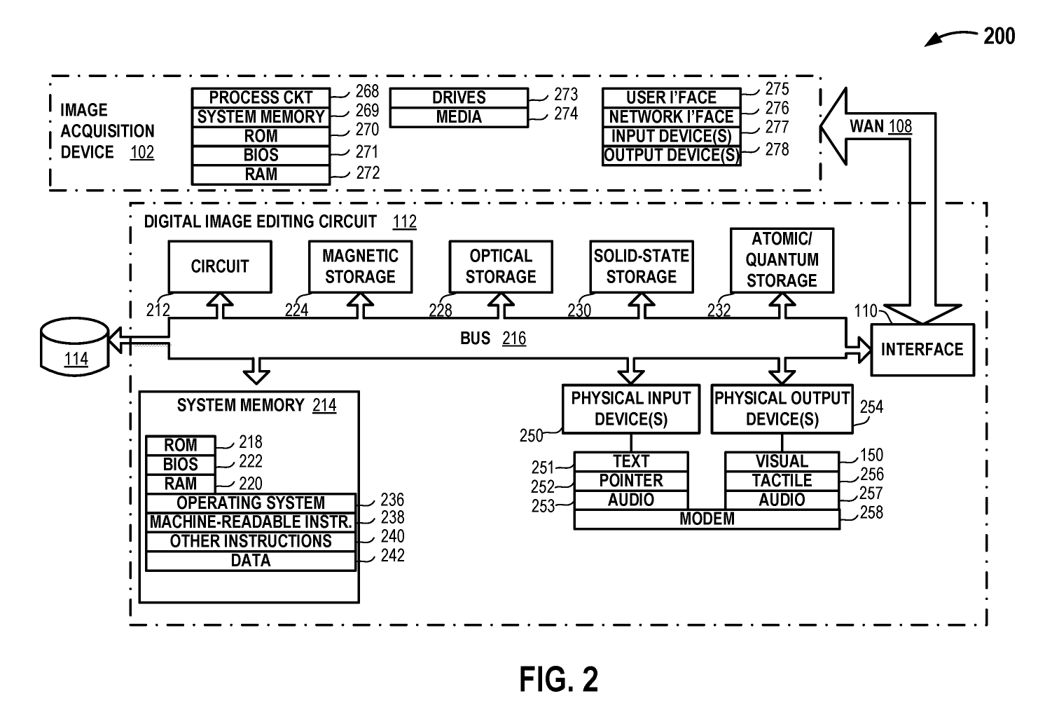

FIG. 2 and the following discussion provide a brief, general description of the components forming the illustrative image editing system 200 including the image acquisition device 102, the image editing circuit 112, and the image display device 150 in which the various illustrated embodiments can be implemented. Although not required, some portion of the embodiments will be described in the general context of machine-readable or computer-executable instruction sets, such as program application modules, objects, or macros being executed by the digital image editing circuit 112. Those skilled in the relevant art will appreciate that the illustrated embodiments as well as other embodiments can be practiced with other circuit-based device configurations, including portable electronic or handheld electronic devices, for instance smartphones, portable computers, wearable computers, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The digital image editing circuit 112 may take the form of a circuit disposed partially or wholly in a PC, server, or other computing system capable of executing machine-readable instructions. The digital image editing circuit 112 includes one or more circuits 212, and may, at times, include a system bus 216 that couples various system components including a system memory 214 to the one or more circuits 212. The digital image editing circuit 112 will at times be referred to in the singular herein, but this is not intended to limit the embodiments to a single system, since in certain embodiments, there will be more than one digital image editing circuit 112 or other networked circuits or devices involved.

The circuit 212 may include any number, type, or combination of devices. At times, the circuit 212 may be implemented in whole or in part in the form of semiconductor devices such as diodes, transistors, inductors, capacitors, and resistors. Such an implementation may include, but is not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), field programmable gate arrays (FPGAs), and the like. Unless described otherwise, the construction and operation of the various blocks shown in FIG. 2 are of conventional design. As a result, such blocks need not be described in further detail herein, as they will be understood by those skilled in the relevant art. The system bus 216 that interconnects at least some of the components of the example digital image editing circuit 212 can employ any known bus structures or architectures.

The system memory 214 may include read-only memory (“ROM”) 218 and random access memory (“RAM”) 220. A portion of the ROM 218 may contain a basic input/output system (“BIOS”) 222. The BIOS 222 may provide basic functionality to the digital image editing circuit 112, for example by causing the circuit to load the machine-readable instruction sets that cause the circuit to function as the digital image editing circuit 112. The digital image editing circuit 112 may include one or more communicably coupled storage devices, such as one or more magnetic storage devices 224, optical storage devices 228, solid-state electromagnetic storage devices 230, atomic or quantum storage devices 232, or combinations thereof.

The storage devices may include interfaces or controllers (not shown) communicatively coupling the respective storage device or system to the bus 216, as is known by those skilled in the art. The storage devices may contain machine-readable instruction sets, data structures, program modules, and other data useful to the digital image editing circuit 112. In some instances, one or more storage devices 114 may also externally communicably couple to the digital image editing circuit 212.

Machine-readable instruction sets 238 and other instruction sets 240 may be stored in whole or in part in the system memory 214. Such instruction sets may be transferred from the storage device 114 and stored in the system memory 214 in whole or in part when executed by the circuit 212. The machine-readable instruction sets 238 may include logic capable of providing the digital image editing system functions and capabilities described herein. For example, one or more machine-readable instruction sets 238 may cause the digital image editing circuit 112 to identify one or more flawed features 124 on a subject 106 included in the first image 104 received at the interface 110. One or more machine-readable instruction sets 238 may cause the digital image editing circuit 112 to uniquely identify the subject 106 in the first image 104, for example using one or more facial recognition methods (e.g., identifying and matching distinguishing landmarks or similar features on a subject that uniquely characterize or identify the subject 106). One or more machine-readable instruction sets 238 may cause the digital image editing circuit 122 to crop or otherwise remove the identified flawed features 124 of the subject 106 included in the first image 104. One or more machine-readable instruction sets 238 may cause the digital image editing circuit 112 to select from the storage device 114 a number of historical images 130 that include the uniquely identified subject 106. One or more machine-readable instruction sets 238 may cause the digital image editing circuit 112 to identify at least one of the number of historical images 130 that include the subject 106 and an unflawed feature 132. One or more machine-readable instruction sets 238 may cause the digital image editing circuit 112 to crop or otherwise remove the identified unflawed features 132 of the subject 106 included in the at least one historical image 130. One or more machine-readable instruction sets 238 may cause the digital image editing circuit 112 to alter the size of the unflawed feature 132 cropped or otherwise removed from the historical image 130 to more closely correspond to the size of the flawed feature 124 appearing in the first image 104. One or more machine-readable instruction sets 238 may cause the digital image editing circuit 112 to alter the pose, two-dimensional rotation, or three-dimensional rotation of the unflawed feature 132 cropped or otherwise removed from the historical image 130 to more closely correspond to the pose, two-dimensional rotation, or three-dimensional rotation of the flawed feature 124 appearing in the first image 104. One or more machine-readable instruction sets 238 may cause the digital image editing circuit 112 to alter the color, lighting, or brightness parameters of the unflawed feature 132 cropped or otherwise removed from the historical image 130 to more closely correspond to the color, lighting, or brightness parameters of the flawed feature 124 appearing in the first image 104. One or more machine-readable instruction sets 238 may cause the digital image editing circuit 112 to combine the unflawed feature 132 cropped or otherwise removed from the at least one historical image 130 with the first image 104 to transform the first image 104 containing the flawed feature 124 to the second image 140 containing the unflawed feature 132.

Users of the digital image editing circuit 112 may provide, enter, or otherwise supply commands (e.g., acknowledgements, selections, confirmations, and similar) as well as information (e.g., subject identification information, color parameters) into the digital image editing circuit 112 using one or more communicably coupled physical input devices 250 such as a text entry device 251 (e.g., keyboard), pointer 252 (e.g., mouse, touchscreen), or audio 253 input device. Some or all of the physical input devices 250 may be physically and communicably coupled to the portable electronic device housing the image editing circuit 112. For example, a portable electronic device such as a smartphone may include a touchscreen user interface that provides a number of physical input devices 250, such as a text entry device 251 and a pointer 252.

Users of the digital image editing circuit 112 may receive output from the digital image editing circuit 112 via one or more physical output devices 254. In at least some implementations, the physical output devices 254 may include, but are not limited to, the image display device 150; one or more tactile output devices 256; one or more audio output devices 258, or combinations thereof. Some or all of the physical input devices 250 and some or all of the physical output devices 254 may be communicably coupled to the digital image editing circuit 112 via one or more wired or wireless interfaces.

For convenience, interface 110, the circuit 212, system memory 214, physical input devices 250 and physical output devices 254 are illustrated as communicatively coupled to each other via the bus 216, thereby providing connectivity between the above-described components. In alternative embodiments, the above-described components may be communicatively coupled in a different manner than illustrated in FIG. 2. For example, one or more of the above-described components may be directly coupled to other components, or may be coupled to each other, via one or more intermediary components (not shown). In some embodiments, bus 216 is omitted and the components are coupled directly to each other using suitable wired or wireless connections.

The image acquisition device 102 may, at times, be disposed in a portable electronic device shared with the digital image editing circuit 112, for example the image acquisition device 102 and the image editing circuit 112 may be disposed in a smartphone housing, portable computer housing, wearable computer housing, or similar handheld device housing. At other times, the image acquisition device 102 may be disposed remote from the digital image editing circuit 112, for example, the image acquisition device 102 may be disposed in a smartphone housing while the digital image editing circuit 112 is disposed in a communicably coupled (e.g., via the Internet) remote desktop or cloud-based server.

FIG. 2 provides an example in which the image acquisition device 102 is disposed remote from the digital image editing circuit 112. In such an instance, the image acquisition device 102 may be communicably coupled to the digital image editing circuit 112 via one or more wide area networks 106. In such an instance the image acquisition device 102 may communicably couple to the digital image editing circuit 112 via the interface 110.

At times, a standalone image acquisition device 102 may include one or more circuits 268 capable of executing one or more machine-readable instruction sets. At times, some or all of the machine-readable instruction sets may be stored or otherwise retained in a system memory 269 within the image acquisition device 102. The system memory 269 may include a read only memory (ROM) 270 and a random access memory 272. The image acquisition device BIOS 271 may be stored, retained, or otherwise occupy a portion of the ROM 270.

The image acquisition device 102 may also include on or more storage devices 273. At times, the storage device 273 may be fixed, for example a solid-state storage device disposed in whole or in part in the image acquisition device 102. At other times, the storage device 273 may include one or more types of removable media 274, for example a secure digital (“SD”), high density SD (HDSD), or micro SD flash storage device.

The image acquisition device 102 may also include one or more user interfaces 275. The user interface 275 may include one or more user input devices 276. Example, non-limiting user input devices 276 may include, but are not limited to, one or more pointers, one or more text input devices, one or more audio input devices, one or more touchscreen input devices, or combinations thereof. The user interface 275 may alternatively or additionally include one or more user output devices 277. Example, non-limiting user output devices 277 may include, but are not limited to, one or more visual output devices, one or more tactile output devices, one or more audio output devices, or combinations thereof.

The circuit 268 may include one or more single- or multi-core processor(s) adapted to execute one or more machine-readable instruction sets (e.g., ARM Cortext-A8, ARM Cortext-A9, Snapdragon 600, Snapdragon 800, NVidia Tegra 4, NVidia Tegra 4i, Intel Atom Z2580, Samsung Exynos 5 Octa, Apple A7, Motorola X8). The circuit 268 may include one or more microprocessors, reduced instruction set computers (RISCs), application specific integrated circuits (ASICs), digital signal processors (DSPs), systems on a chip (SoCs) or similar.

The system memory 269 may store all or a portion of a basic input/output system (BIOS), boot sequence, firmware, startup routine, or similar. The system memory 269 may store all or a portion of the image acquisition device 102 operating system (e.g., iOS®, Android®, Windows® Phone, Windows® 10, and similar) executed by the circuit 268 upon initial application of power.

The image acquisition device 102 may include one or more wired or wireless communications interfaces 276. In some instances, the one or more wired or wireless communications interfaces may include one or more transceivers or radios or similar current or future developed interfaces capable of transmitting and receiving communications via electromagnetic energy. Non-limiting examples of such wireless communications interfaces include cellular communications transceivers or radios (e.g., a CDMA transceiver, a GSM transceiver, a 3G transceiver, a 4G transceiver, an LTE transceiver). Non-limiting examples of IEEE 802.11 transceivers include WIFI® short-range transceivers or radios 290 include various chipsets available from Broadcom, including BCM43142, BCM4313, BCM94312MC, BCM4312, and chip sets available from Atmel, Marvell, or Redpine. Nonlimiting examples of BLUETOOTH® short-range transceivers or radios include various chipsets available from Nordic Semiconductor, Texas Instruments, Cambridge Silicon Radio, Broadcom, and EM Microelectronic.

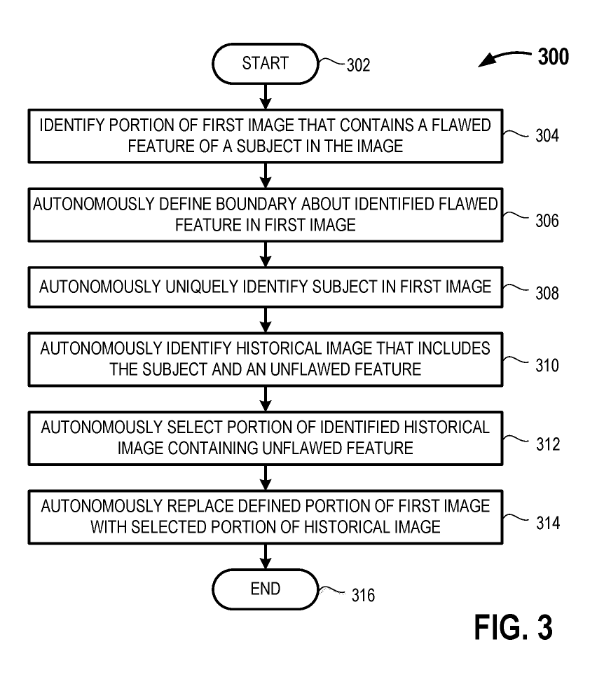

FIG. 3 is a high-level flow diagram of an illustrative image flaw detection and correction method 300, in accordance with at least one embodiment of the present disclosure. The method 300 includes detecting a portion of a subject contained in a first image that includes a flawed feature. The method 300 further includes using one or more recognition techniques to uniquely identify the subject 106 included in the first image 104. The method 300 further includes identifying a number of historical images 130 in which the subject appears and selecting one of the historical images 130 in which the flawed feature 124 in the first image 104 appears unflawed. For example, if the subject's eyes are closed (i.e., the flawed feature 124) in the first image, a historical image in which the subject's eyes are opened (i.e., the unflawed feature 132) may be selected. The method includes selecting a portion of the historical image 130 containing the unflawed feature 132 corresponding to the identified portion of the first image 104 that contains the flawed feature 124. The selected portion of the historical image is then used to replace the identified portion of the first image. The method 300 commences at 302.

At 304, the image editing circuit 112 autonomously identifies a portion of the first image 104 that contains a subject 106 having one or more flawed features 124. In some instances, the image editing circuit 112 autonomously identifies the one or more flawed features 124 based on the presence or absence of established or defined landmarks (e.g., absence of landmarks indicating a subject's eyes are open in the first image 104).

In embodiments, the image editing circuit 112 may selectively autonomously identify any number of specifically enumerated flawed features. At times, the user of the image acquisition device 102 may provide such specifically enumerated flawed features 124. For example, the user may elect to have only flawed features indicative of a closed eye replaced by the image editing circuit 112. Such selective replacement of flawed features 124 may beneficially permit flawed features indicative of the spontaneity of the situation or indicative of a candid first image to remain in the second image 140.

At 306, the image editing circuit 112 may define a boundary or similar limitation about the flawed feature 124 appearing in the first image 104. In embodiments, such a defined boundary or limitation about the flawed feature 124 denotes the extent of the flawed feature 124. At times such a defined boundary may take a geometric form (i.e., circle, square, rectangular, polygonal) or may take a freeform form (i.e., following facial features, such as cheekbones, of a subject 106). In embodiments, the defined boundary about the flawed feature 124 may define the extent of a replacement area for future insertion of an unflawed feature 132.

At 308, the image editing circuit 112 autonomously uniquely identifies the subject 106 possessing or having the flawed feature 124 and appearing in the first image 104. Such unique identification may be performed using one or more recognition devices or systems. One such non-limiting example is a facial recognition system using a pattern of defined or otherwise known landmarks to uniquely identify the subject 106 appearing in the first image 104.

At 310, the image editing circuit 112 autonomously searches one or more storage devices 114 to autonomously identify a number of historical images 130 that include the subject 106 appearing in the first image 104. In embodiments, the image editing circuit 112 may identify some or all of the number of historical images 130 stored or otherwise retained on one or more local storage devices, such as one or more solid state drives locally communicably coupled to the image editing circuit 112. In embodiments, the image editing circuit 112 may identify some or all of the number of historical images 130 stored or otherwise retained on one or more remote storage devices 114, for example on one or more cloud-based servers.

In embodiments, at least a portion of the historical images 130 may be provided by the system user as a “training set” containing various subjects 106 having unflawed features 132. One may, for example, provide a series of images of family and friends (i.e., likely subjects 106 in future images) in which the subjects have unflawed features (e.g., open eyes, smiling) In at least some implementations, the historical images 130 included in such a training set may be tagged or may contain unique identifiers corresponding to the subjects 106 appearing in each of the images. In this manner, the training set may also assist the image editing circuit 112 in establishing facial landmarks for each individual, thereby improving the accuracy of the future automated subject identification process.

The image editing circuit 112 autonomously selects at least one of the number of identified historical images 130 containing the subject 106 and including an unflawed feature 132 of the subject 106. In embodiments, the image editing circuit 112 may autonomously select the historical image 130 based at least in part one the existence of an unflawed feature 132. Replacing the flawed feature 124 of the subject 106 in the first image 104 with an unflawed feature 132 of the same subject 106 in one or more historical images 130 beneficially improves the natural appearance of the subject in the resultant second image 140 because the subject's own features have been used by the image editing circuit 112.

At 312, the image editing circuit 112 selects a portion of the historical image 130 containing the unflawed feature 132. The image editing circuit 112 may detect the presence of the unflawed feature 132 e.g., presence of landmarks indicating the subject's eyes are open in the historical image 130) based on the presence or absence of one or more established or defined landmarks indicative of the unflawed feature 132. In embodiments, the image editing circuit 112 may form or otherwise define a boundary or similar limitation about the unflawed feature 132 appearing in the first image 104. In embodiments, the boundary or similar limitation about the unflawed feature 132 in the historical image 130 may correspond to the boundary or similar limitation about the flawed feature 124 in the first image.

At 314, the image editing circuit 112 autonomously replaces the identified portion of the first image containing the flawed feature 124 with the selected portion of the historical image 130 containing the unflawed feature 132. The resultant second image 140 is similar in content to the first image 104, however the flawed feature 124 in the first image 104 is replaced with the unflawed feature 132 selectively removed from the historical image 130. The method 300 concludes at 316.

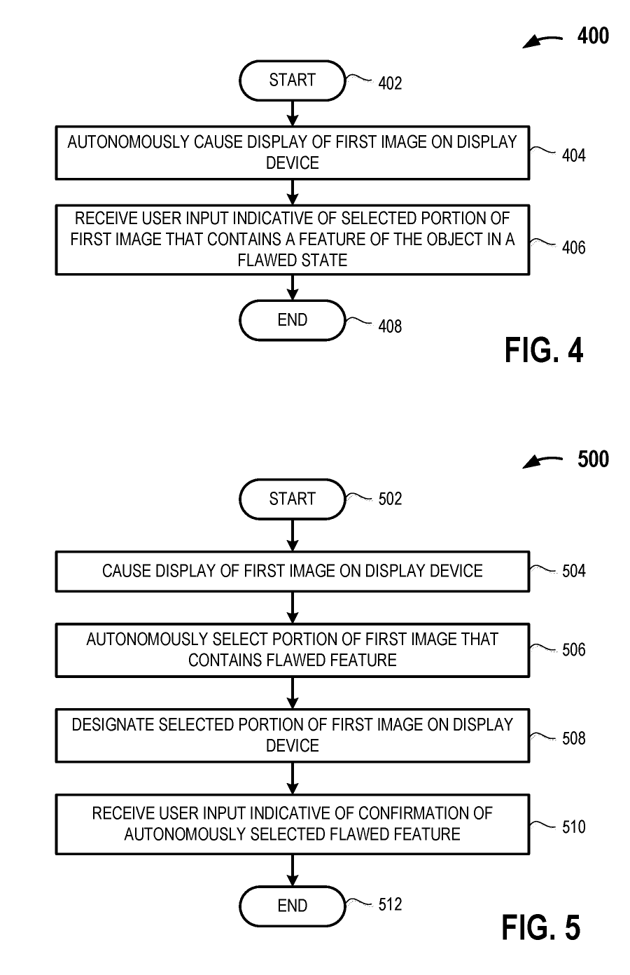

FIG. 4 is a high-level flow diagram of an illustrative image flaw detection and correction method 400 in which the image editing circuit 112 receives a user input indicative of the flawed feature 124 in the first image 104, in accordance with at least one embodiment of the present disclosure. At times, rather than allowing the image editing circuit 112 to autonomously identify the flawed feature 124 in the first image 104, the device user may instead prefer to manually identify the flawed feature 124. In such instances, one or more input devices 277 communicably coupled to the image editing circuit 112 may be used to receive user input and communicate the input to the image editing circuit 112. The method 400 commences at 402.

At 404, responsive to an input indicative of a user's desire to manually select the flawed feature 124 in the first image 104, the image editing circuit 112 causes a display of the first image 104 on an output device 278 communicably coupled to the image editing circuit 112.

At 406, the image editing circuit 112 receives an input indicative of the user-selected portion of the first image 104 that includes the flawed feature 124. In embodiments, the image editing circuit 112 may receive the user-input in the form of a coordinate set corresponding to a pointer-based input (e.g., touchscreen-based input) provided by the user of the device. In other embodiments, the image editing circuit 112 may receive the user-input in the form of audio that, in conjunction with the unique identification of the subject 106 in the first image 104 by the image editing circuit 112. Such a system permits a user to use audio commands such as, “Fix Tom's eyes” and responsive to the command, the image editing circuit 112 identifies and defines a boundary about the eyes of the subject 106 uniquely identified as “Tom” in the first image 104.

Such manual flawed feature identification may occur in place of or in conjunction with the autonomous selection of flawed features by the image editing circuit 112. For example, the image editing circuit 112 may delay the autonomous identification and selection of flawed features 124 in the first image 104 for a defined time interval (e.g., 30 seconds, 1 minute, 2 minutes, 5 minutes) to permit the device user's manual identification and selection of flawed features 124. The method 400 concludes at 408.

FIG. 5 is a high-level flow diagram of an illustrative image flaw detection and correction method 500 in which the image editing circuit 112 receives a user input confirming the autonomously selected portion of the flawed feature 124 in the first image 104, in accordance with at least one embodiment of the present disclosure. At times, the automated flaw detection and selection capabilities of the image editing circuit 112 may result in the correction of an image element detected as a flow but which is, in fact, a desirable element the system user wishes to retain in the first image 104. For example, a wink captured in the first image 104 may be identified as a feature flow (e.g., a “closed eye”) by the image editing circuit 112. In such instances, it is helpful if the system user is provided the capability to abort or otherwise reject the autonomous selection of the image editing system 112. The method 500 commences at 502.

At 504, the image editing circuit 112 causes a display of the first image 104 on an output device 278 communicably coupled to the image editing circuit 112.

At 506, the image editing circuit 112 autonomously selects a portion of the first image 104 that contains a subject 106 having a proposed flawed feature 124. In some instances, the image editing circuit 112 autonomously identifies the one or more proposed flawed features 124 based on the presence or absence of established or defined landmarks (e.g., absence of landmarks indicating a subject's eyes are open in the first image 104).

At 508, the image editing circuit 112 causes a display of a boundary or similar identifier about all or a portion of the autonomously identified proposed flawed feature 124. The boundary enables the user to quickly discern the flawed feature 124 detected by the image editing circuit 112.

At 510, the image editing circuit 112 receives user input indicative of a confirmation or rejection of the proposed flawed feature 124. In embodiments, the confirmation or rejection of the proposed flawed feature 124 may be performed using one or more icons on a display device 150. For example, a user-selectable button labeled “ACCEPT” and a user-selectable button labeled “REJECT” on the display device 150. In embodiments, the image editing circuit 112 may provide the user with the ability to manually define the scope or extent of the flawed feature 124 upon rejection of the autonomously selected portion of the first image 104. The method 500 concludes at 512.

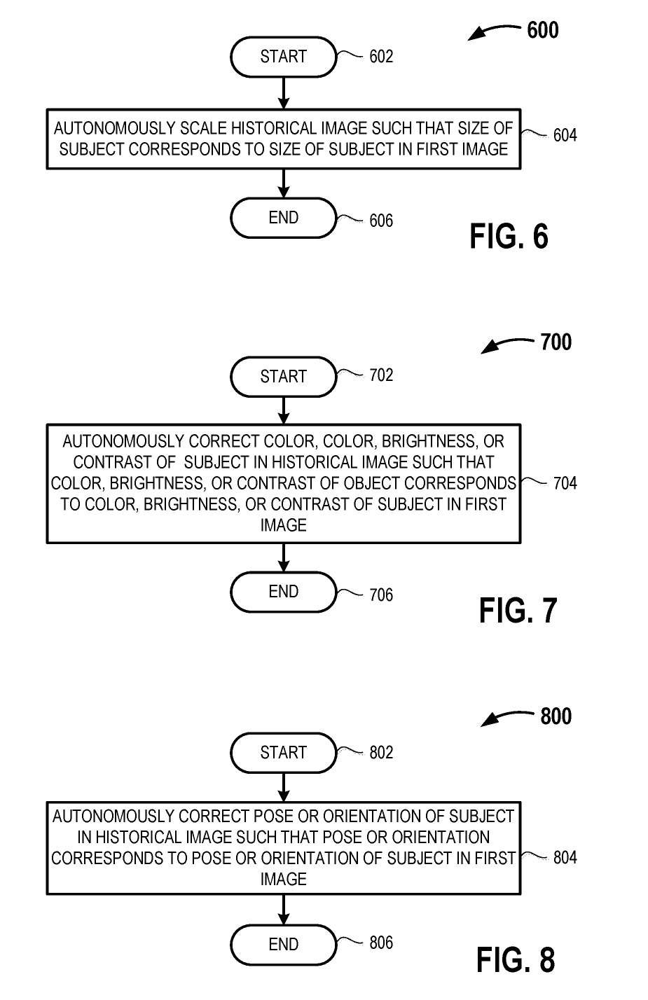

FIG. 6 is a high-level flow diagram of an illustrative image flaw detection and correction method 600 in which the image editing circuit 112 autonomously scales the historical image 130 such that the size of the subject 106 in the historical image 130 corresponds to the size of the subject 106 in the first image 104, in accordance with at least one embodiment of the present disclosure. At times, the subject 106 in the historical image 130 may be of a different size than the subject 106 in the first image 104. Rather than discard the historical image 130, at times the image editing circuit 112 can scale or otherwise resize the historical image 130 such that the size of the subject 106 included in the historical image corresponds to the size of the subject 106 in the first image 104. The method 600 commences at 602.

At 604, the image editing circuit 112 autonomously scales the historical image 130 such that the size of the subject 106 appearing in the historical image 130 corresponds to or otherwise approximates the size of the subject 106 appearing in the first image 104. In some instances, the upscaling of the historical image may be limited (e.g., about 125%, about 150%, about 200%, about 250%, about 300%, about 500%) to minimize pixilation in the scaled historical image 130 and preserve image quality in the resultant second image 150.

In some instances, the image editing circuit 112 autonomously scales the historical image 130 and applies the scaled unflawed feature 132 to the first image 104 without user intervention. In other instances, the image editing circuit 112 autonomously scales the historical image 130 and provides the system user with the ability to ACCEPT or REJECT the scaled historical image 130 as the source for the unflawed feature 132. The method 600 concludes at 606.

FIG. 7 is a high-level flow diagram of an illustrative image flaw detection and correction method 700 in which the image editing circuit 112 autonomously corrects one or more color, brightness, or contrast parameters of the historical image 130 such that the one or more color, brightness, or contrast parameters of the subject 106 in the historical image 130 corresponds to the one or more color, brightness, or contrast parameters of the subject 106 in the first image 104, in accordance with at least one embodiment of the present disclosure. At times, the historical image 130 may have different exposure or white balance characteristics than the first image 104. In such instances, the selection of an unflawed feature 132 from the historical image may result in an odd or unusual appearance in the second image 150 when the flawed feature is replaced. Rather than discard the historical image 130, at times the image editing circuit 112 may autonomously correct one or more color, brightness, or contrast parameters of the historical image 130 such that the color, brightness, or contrast parameters of the subject 106 included in the historical image correspond to the color, brightness, or contrast parameters of the subject 106 in the first image 104. The method 700 commences at 702.

At 704, the image editing circuit 112 autonomously corrects one or more color, brightness, or contrast parameters of the historical image 130 such that the color, brightness, or contrast parameters of the subject 106 appearing in the historical image 130 correspond to or otherwise approximates the color, brightness, or contrast parameters of the subject 106 appearing in the first image 104.

In some instances, the image editing circuit 112 autonomously corrects one or more color, brightness, or contrast parameters the historical image 130 and applies the color corrected unflawed feature 132 to the first image 104 without user intervention. In other instances, the image editing circuit 112 autonomously corrects one or more color, brightness, or contrast parameters of the historical image 130 and provides the system user with the ability to ACCEPT or REJECT the color corrected historical image 130 as the source for the unflawed feature 132. The method 700 concludes at 706.

FIG. 8 is a high-level flow diagram of an illustrative image flaw detection and correction method 800 in which the image editing circuit 112 autonomously corrects the pose or orientation of the subject 106 appearing in the historical image 130 such that the pose or orientation of the subject 106 in the historical image 130 corresponds to the pose or orientation of the subject 106 in the first image 104, in accordance with at least one embodiment of the present disclosure. At times, the subject 106 appearing in a historical image 130 may have a different pose or orientation than the subject appearing in the first image 104. In such instances, the selection of an unflawed feature 132 from the historical image may result in an odd or unusual appearance in the second image 150 when the flawed feature 132 is replaced with the unflawed feature 132. Rather than discard the historical image 130, at times the image editing circuit 112 may autonomously correct the pose or orientation of the subject in the historical image 130 such that the pose or orientation of the subject 106 included in the historical image correspond to pose or orientation of the subject 106 in the first image 104. The method 800 commences at 802.

At 804, the image editing circuit 112 autonomously corrects the pose or orientation of the subject 106 in the historical image 130 such that the pose or orientation of the subject 106 appearing in the historical image 130 corresponds to or otherwise approximates the pose or orientation of the subject 106 appearing in the first image 104.

In some instances, the image editing circuit 112 autonomously corrects the pose or orientation of the subject 106 appearing the historical image 130 and applies the pose or orientation corrected unflawed feature 132 to the first image 104 without user intervention. In other instances, the image editing circuit 112 autonomously corrects the pose or orientation of the subject 106 appearing in the historical image 130 and provides the system user with the ability to ACCEPT or REJECT the pose or orientation corrected historical image 130 as the source for the unflawed feature 132. The method 800 concludes at 806.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for binding a trusted input session to a trusted output session to prevent the reuse of encrypted data obtained from prior trusted output sessions.

According to example 1 there is provided a system that detects and replaces flaws in digital images. The system may include an interface to receive a first image and a circuit communicably coupled to the interface. The system may additionally include a storage device communicably coupled to the circuit. The storage device may include data representative of a number of historical images and a machine-readable instruction set. The machine-readable instruction set, when executed by the circuit causes the circuit to provide an image editing circuit. The image editing circuit identifies, in the received first image, a portion of a subject containing a flawed feature. The image editing circuit further autonomously uniquely identifies the subject with the flawed feature in the first image. The image editing circuit further autonomously identifies at least one historical image from the number of historical images that includes the subject with an unflawed feature that corresponds to the flawed feature. The image editing circuit further autonomously selects a portion of the at least one historical image that contains the unflawed feature, the selected portion corresponding to the identified portion of the first image. The image editing circuit further autonomously replaces the identified portion of the first image with the selected portion of the at least one historical image.

Example 2 may include elements of example 1 and may further include a display device communicably coupled to the circuit and a user input device communicably coupled to the circuit. The machine-readable instruction set that causes the image editing circuit to identify, in the received first image, a portion of a subject containing a flawed feature may further cause the image editing circuit to display the first image on the display device and receive, via the user input device, a user input indicative of a selection of a portion of the subject appearing in the first image containing the flawed feature.

Example 3 may include elements of example 1 and may further include a display device communicably coupled to the circuit and a user input device communicably coupled to the circuit. The machine-readable instruction set that causes the image editing circuit to identify, in the received first image, a portion of a subject containing a flawed feature may further cause the image editing circuit to display the first image on the display device and autonomously select the portion of the subject appearing in the first image and in which the flawed feature appears. The machine-readable instruction set may also cause the image editing circuit to receive, via the user input device, a user input indicative of either: a confirmation of the autonomously selected portion of the first image; or an input corresponding to a user selected portion of the first image that in which the flawed feature appears.

Example 4 may include elements of example 1 where the machine-readable instruction set that causes the image editing circuit to identify a portion of a subject containing a flawed feature may further cause the image editing circuit to identify a portion of the first image in which a flawed anatomical feature of an animate subject appears.

Example 5 may include elements of example 4 where the machine-readable instruction set that causes the image editing circuit to identify a portion of the first image in which a flawed anatomical feature of an animate subject appears may further cause the image editing circuit to identify a portion of the first image in which a flawed facial feature of a human subject appears.

Example 6 may include elements of example 5 where the machine-readable instruction set that causes the image editing circuit to uniquely identify the subject with the flawed feature in the first image may further cause the digital image editing circuit to uniquely identify, via an automated facial recognition, the subject appearing in the first image.

Example 7 may include elements of any of examples 1 through 6 where the machine-readable instruction set that causes the image editing circuit to autonomously identify at least one historical image from the number of historical images that includes the subject with an unflawed feature that corresponds to the flawed feature may further cause the image editing circuit to autonomously select at least one historical image from the number of historical images, the at least one selected historical image including a pose of the subject that corresponds to a pose of the subject in the first image.

Example 8 may include elements of any of examples 1 through 6 where the machine-readable instruction set that causes the image editing circuit to autonomously replace the identified portion of the first image with the selected portion of the at least one historical image may further cause the image editing circuit to autonomously scale the at least one historical image such that a size of the subject in the at least one identified historical image corresponds to a size of the subject in the first image.

Example 9 may include elements of any of examples 1 through 6 where the machine-readable instruction set that causes the image editing circuit autonomously replace the identified portion of the first image with the selected portion of the at least one historical image may further causes the image editing circuit to autonomously correct the at least one historical image such that at least one of a color, a brightness, or a contrast of the subject in the at least one identified historical image corresponds to at least one of a color, a brightness, or a contrast of the subject in the first image.

Example 10 may include elements of any of examples 1 through 6 where the machine-readable instruction set that causes the image editing circuit to autonomously replace the identified portion of the first image with the selected portion of the at least one historical image may further causes the image editing circuit to autonomously alter a physical parameter of the object in the at least one identified historical image such that at least one of: a pose of the subject or a rotation of the subject corresponds to at least one of: a pose of the subject or a rotation of the subject in the first image.

According to example 11 there is provided a method of causing a circuit to provide an image editing circuit. The method may include identifying, by the image editing circuit, a portion a subject appearing in a first image received from a communicably coupled image acquisition device, the identified portion of the subject having at least one flawed feature.

The method may further include autonomously uniquely identifying, by the image editing circuit, the subject appearing in the first image. The method may further include identifying, by the image editing circuit, at least one historical image stored on a communicably coupled storage device, the at last one historical image including the subject in which appears an unflawed feature corresponding to the identified flawed feature in the first image. The method may additionally include selecting, by the image editing circuit, a portion of the at least one historical image in which the unflawed feature appears, the selected portion of the at least one historical image corresponding to the identified portion of the first image. The Method further includes replacing, by the image editing circuit, the identified portion of the first image with the selected portion of the at least one historical image to provide a second image in which the flawed feature is absent.

Example 12 may include elements of example 11 where identifying a portion of the subject having a flawed feature may include causing, by the image editing circuit, a display of the first image on a communicably coupled display device and receiving, by the image editing circuit, a user input corresponding to a selected portion of the first image in which the flawed feature appears.

Example 13 may include elements of example 11 where identifying a portion of the subject having a flawed feature may include causing, by the image editing circuit, a display of the first image on a communicably coupled display device, autonomously identifying, by the image editing circuit, the portion of the first image that contains the flawed feature and receiving, via the user input device, a user input indicative of either: a confirmation of the autonomously selected portion of the first image; or an input corresponding to a user selected portion of the first image that in which the flawed feature appears.

Example 14 may include elements of example 11 where identifying a portion of the subject having a flawed feature may include identifying, by the image editing circuit, a portion of the first image in which a flawed anatomical feature of an animate object appears.

Example 15 may include elements of example 14 where identifying, by the image editing circuit, a portion of the first image in which a flawed anatomical feature of an animate object appears may include identifying, by the image editing circuit, a portion of the first image in which a flawed facial feature of a human subject appears.

Example 16 may include elements of example 15 where identifying, by the image editing circuit, at least one historical image stored on a communicably coupled storage device, the at last one historical image including the subject in which appears an unflawed feature corresponding to the identified flawed feature in the first image may include autonomously identifying, by the image editing circuit, the at least one historical image via an automated facial recognition of the human subject in the at least one historical image and which corresponds to the uniquely identified human subject appearing in the first image.

Example 17 may include elements of any of examples 11 through 16 where identifying at least one historical image that includes the object and an unflawed feature from a number of historical digital images stored on a communicably coupled storage device may include autonomously scaling, by the image editing circuit, the at least one historical image such that a size of the subject in the at least one historical image corresponds to a size of the subject in the first image.

Example 18 may include elements of any of examples 11 through 16 where identifying at least one historical image that includes the object and an unflawed feature from a number of historical digital images stored on a communicably coupled storage device comprises autonomously correcting, by the image editing circuit, the at least one historical image such that at least one of a color, a brightness, or a contrast of the subject in the at least one identified historical image corresponds to at least one of a color, a brightness, or a contrast of the subject in the first image.

Example 19 may include elements of any of examples 11 through 16 where identifying at least one historical image that includes the object and an unflawed feature from a number of historical digital images stored on a communicably coupled storage device comprises autonomously altering, by the image editing circuit, a physical parameter of the subject in the at least one identified historical image such that at least one of: a pose of the subject or a rotation of the subject corresponds to at least one of: a pose of the subject or a rotation of the subject in the first image.

According to Example 20, there is provided a storage device containing a machine-readable instruction set that, when executed by a circuit, causes the circuit to provide image editing circuit. The image editing circuit may identify a portion a subject appearing in a first image received from a communicably coupled image acquisition device, the identified portion of the subject having at least one flawed feature. The image editing circuit may further autonomously uniquely identify the subject appearing in the first image. The image editing circuit may further autonomously identify at least one historical image stored on a communicably coupled storage device, the at last one historical image including the subject with an unflawed feature corresponding to the identified flawed feature in the first image. The image editing circuit may further autonomously select a portion of the at least one historical image in which the unflawed feature appears, the selected portion of the at least one historical image corresponding to the identified portion of the first image. The image editing circuit may additionally autonomously replace the identified portion of the first image with the selected portion of the at least one historical image to provide a second image in which the flawed feature is absent.

Example 21 may include elements of example 20 where the machine-readable instruction set that causes the image editing circuit to identify a portion a subject appearing in a first image received from a communicably coupled image acquisition device, the identified portion of the subject having at least one flawed feature may further cause the image editing circuit to display the first image on the display device and receive a user input from a communicably coupled user input device, the user input including information corresponding to a user-selected portion of the first image containing the flawed feature.

Example 22 may include elements of example 20 where the machine-readable instruction set that causes the image editing circuit to identify a portion a subject appearing in a first image received from a communicably coupled image acquisition device, the identified portion of the subject having at least one flawed feature cause the image editing circuit to cause a display of the first image on a communicably coupled display device, autonomously identify the portion of the first image that contains the flawed feature, and receive a user input indicative of either: a confirmation of the autonomously selected portion of the first image; or an input corresponding to a user-selected portion of the first image that in which the flawed feature appears.

Example 23 may include elements of example 20 where the machine-readable instruction set that causes the image editing circuit to identify a portion a subject having at least one flawed feature further cause the digital image editing circuit to select a portion of an animate subject having at least one flawed anatomical feature.

Example 24 may include elements of example 23 where the machine-readable instruction set that causes the image editing circuit to identify a portion a subject having at least one flawed feature further cause the digital image editing circuit to select a portion of a human subject having at least one flawed facial feature.

Example 25 may include elements of example 24 where the machine-readable instruction set that causes the image editing circuit to autonomously identify at least one historical image stored on a communicably coupled storage device, the at last one historical image including the subject and containing a unflawed feature corresponding to the identified flawed feature in the first image further cause the digital image editing circuit to autonomously identify at least one historical image in which the human subject appears, the human subject identified via an automated facial recognition, the at least one identified historical image including the human subject in which an unflawed facial feature appears.

Example 26 may include elements of any of examples 20 through 25 where the machine-readable instruction set that causes the image editing circuit to autonomously identify at least one historical image stored on a communicably coupled storage device, the at last one historical image including the subject with a unflawed feature corresponding to the identified flawed feature in the first image further cause the digital image editing circuit to autonomously select at least one historical image including a pose of the subject that corresponds to a pose of the subject in the first image.

Example 27 may include elements of any of examples 20 through 25 where the machine-readable instruction set that causes the image editing circuit to autonomously identify at least one historical image stored on a communicably coupled storage device, the at last one historical image including the subject with a unflawed feature corresponding to the identified flawed feature in the first image further cause the digital image editing circuit to autonomously scale the at least one historical image such that a size of the subject in the at least one identified historical image corresponds to a size of the subject in the first image.

Example 28 may include elements of any of examples 20 through 25 where the machine-readable instruction set that causes the image editing circuit to autonomously identify at least one historical image stored on a communicably coupled storage device, the at last one historical image including the subject with a unflawed feature corresponding to the identified flawed feature in the first image further cause the digital image editing circuit to autonomously correct the at least one historical image such that at least one of a color, a brightness, or a contrast of the subject in the at least one identified historical image corresponds to at least one of a color, a brightness, or a contrast of the subject in the first image.

Example 29 may include elements of any of examples 20 through 25 where the machine-readable instruction set that causes the image editing circuit to autonomously identify at least one historical image stored on a communicably coupled storage device, the at last one historical image including the subject with a unflawed feature corresponding to the identified flawed feature in the first image further cause the digital image editing circuit to autonomously alter a physical parameter of the subject in the at least one identified historical image such that at least one of: a pose of the subject or a rotation of the subject corresponds to at least one of: a pose of the subject or a rotation of the subject in the first image.

According to example 30, there is provided a system that causes a circuit to provide a digital image editing circuit. The system may include a means for identifying a portion a subject appearing in a first image received from a communicably coupled image acquisition device, the identified portion of the subject having at least one flawed feature. The system may further include a means for autonomously uniquely identifying the subject appearing in the first image. The system may additionally include a means for autonomously identifying at least one historical image stored on a communicably coupled storage device, the at last one identified historical image including the subject in which an unflawed feature corresponding to the identified flawed feature in the first image appears. The system may further include a means for autonomously selecting a portion of the at least one historical image in which the unflawed feature appears, the selected portion of the at least one historical image corresponding to the identified portion of the first image. The system may additionally include a means for autonomously replacing the identified portion of the first image with the selected portion of the at least one historical image to provide a second image in which the flawed feature is absent.

Example 31 may include elements of example 30 where the means for identifying a portion a subject appearing in a first image received from a communicably coupled image acquisition device, the identified portion of the subject having at least one flawed feature may include a means for causing a display of the first image on a communicably coupled display device and a means for receiving a user input corresponding to a selected portion of the first image in which the flawed feature appears.

Example 32 may include elements of example 30 where the means for selecting a portion of the first image received from a communicably coupled digital image source that contains a flawed feature of an object may include a means for causing a display of the first image on a communicably coupled display device, a means for autonomously identifying the portion of the first image that contains the flawed feature, and a means for receiving a user input indicative of either: a confirmation of the autonomously selected portion of the first image; or an input corresponding to a user selected portion of the first image that in which the flawed feature appears.

Example 33 may include elements of example 30 where the means for identifying a portion a subject appearing in a first image, the identified portion of the subject having at least one flawed feature may include a means for identifying a portion of the first image in which a flawed anatomical feature of an animate object appears.

Example 34 may include elements of example 33 where the means for identifying a portion of the first image in which a flawed anatomical feature of an animate object appears may include a means for identifying a portion of the first image in which a flawed facial feature of a human subject appears.

Example 35 may include elements of example 34 where the means for identifying at least one historical image including the subject in which an unflawed feature corresponding to the identified flawed feature in the first image appears may include a means for autonomously identifying the at least one historical image via an automated facial recognition of the human subject in the at least one historical image and which corresponds to the uniquely identified human subject appearing in the first image.

Example 36 may include elements of example 35 where the means for autonomously identifying at least one historical image including the subject in which an unflawed feature corresponding to the identified flawed feature in the first image appears may include a means for autonomously selecting at least one historical image, the at least one selected historical image including a pose of the subject that corresponds to a pose of the subject in the first image.

Example 37 may include elements of any of examples 30 through 35 where the means for autonomously replacing the identified portion of the first image with the selected portion of the at least one historical image may include a means for autonomously scaling the at least one historical image such that a size of the subject in the at least one identified historical image corresponds to a size of the subject in the first image.

Example 38 may include elements of any of examples 30 through 35 the means for autonomously replacing the identified portion of the first image with the selected portion of the at least one historical image may include a means for autonomously correcting the at least one historical image such that at least one of a color, a brightness, or a contrast of the subject in the at least one identified historical image corresponds to at least one of a color, a brightness, or a contrast of the subject in the first image.

Example 39 may include elements of any of examples 30 through 35 where the means for autonomously replacing the identified portion of the first image with the selected portion of the at least one historical image may include a means for autonomously altering a physical parameter of the subject in the at least one identified historical image such that at least one of: a pose of the subject or a rotation of the subject corresponds to at least one of: a pose of the subject or a rotation of the subject in the first image.

According to example 40, there is provided a system that causes a circuit to provide a digital image editing circuit, the system being arranged to perform the method of any of examples 11 through 19.

According to example 41, there is provided a chipset arranged to perform the method of any of examples 11 through 19.

According to example 42, there is provided at least one machine readable medium comprising a plurality of instructions that, in response to be being executed on a computing device, cause the computing device to carry out the method according to any of claims 11 through 19.

According to example 43, there is provided a device configured to cause a circuit to provide a digital image editing circuit, the device being arranged to perform the method of any of claims 11 through 19.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1-25. (canceled)

26. A system that detects and replaces flaws in digital images, the system comprising:
an interface to receive a first image;
a circuit communicably coupled to the interface; and
a storage device communicably coupled to the circuit and including:
data representative of a number of historical images; and
a machine-readable instruction set, that when executed by the circuit causes the circuit to provide an image editing circuit to:
identify, in the received first image, a portion of a subject in which a flawed feature appears;
autonomously uniquely identify the subject with the flawed feature in the first image;
autonomously identify at least one historical image from the number of historical images, the identified at least one historical image including the subject with an unflawed feature that corresponds to the flawed feature;
autonomously select a portion of the subject appearing in the at least one historical image, the selected portion of the at least one historical image including the unflawed feature and corresponding to the flawed feature in the identified portion of the first image; and
autonomously replace the identified portion of the first image with the selected portion of the at least one historical image.

27. The system of claim 26, further comprising:
a display device communicably coupled to the circuit; and
a user input device communicably coupled to the circuit;
wherein the machine-readable instruction set that causes the image editing circuit to identify, in the received first image, a portion of a subject containing a flawed feature further causes the image editing circuit to:
display the first image on the display device; and
receive, via the user input device, a user input indicative of a selection of a portion of the subject appearing in the first image containing the flawed feature.

28. The system of claim 26, further comprising:
a display device communicably coupled to the circuit; and
a user input device communicably coupled to the circuit;
wherein the machine-readable instruction set that causes the image editing circuit to identify, in the received first image, a portion of a subject containing a flawed feature further causes the image editing circuit to:
display the first image on the display device;
autonomously select the portion of the subject appearing in the first image in which the flawed feature appears; and
receive, via the user input device, a user input indicative of either: a confirmation of the autonomously selected portion of the first image; or an input corresponding to a user selected portion of the first image that in which the flawed feature appears.

29. The system of claim 26 wherein the machine-readable instruction set that causes the image editing circuit to identify, in the received first image, a portion of a subject containing a flawed feature further causes the image editing circuit to:
identify a portion of the first image in which a flawed anatomical feature of an animate subject appears.

30. The system of claim 29 wherein the machine-readable instruction set that causes the image editing circuit to identify a portion of the first image in which a flawed anatomical feature of an animate subject appears further causes the image editing circuit to:
identify a portion of the first image in which a flawed facial feature of a human subject appears.

31. The system of claim 30 wherein the machine-readable instruction set that causes the image editing circuit to uniquely identify the subject with the flawed feature in the first image further causes the digital image editing circuit to:
uniquely identify, via an automated facial recognition, the subject appearing in the first image.

32. The system of claim 26 wherein the machine-readable instruction set that causes the image editing circuit to autonomously identify at least one historical image from the number of historical images that includes the subject with an unflawed feature that corresponds to the flawed feature, further causes the image editing circuit to:
autonomously select at least one historical image from the number of historical images, the at least one selected historical image including a pose of the subject that corresponds to a pose of the subject in the first image.

33. The system of claim 26 wherein the machine-readable instruction set that causes the image editing circuit to autonomously replace the identified portion of the first image with the selected portion of the at least one historical image further causes the image editing circuit to:
autonomously scale the at least one historical image such that a size of the subject in the at least one identified historical image corresponds to a size of the subject in the first image.

34. The system of claim 26 wherein the machine-readable instruction set that causes the image editing circuit to autonomously replace the identified portion of the first image with the selected portion of the at least one historical image further causes the image editing circuit to:
autonomously correct the at least one historical image such that at least one of a color, a brightness, or a contrast of the subject in the at least one identified historical image corresponds to at least one of a color, a brightness, or a contrast of the subject in the first image.

35. The system of claim 26 wherein the machine-readable instruction set that causes the image editing circuit to autonomously replace the identified portion of the first image with the selected portion of the at least one historical image further causes the image editing circuit to:
autonomously alter a physical parameter of the object in the at least one identified historical image such that at least one of: a pose of the subject or a rotation of the subject corresponds to at least one of: a pose of the subject or a rotation of the subject in the first image.

36. A method of causing a circuit to provide an image editing circuit, the method comprising:
identifying, by the image editing circuit, a portion a subject appearing in a first image received from a communicably coupled image acquisition device, the identified portion of the subject having a flawed feature;
autonomously uniquely identifying, by the image editing circuit, the subject appearing in the first image;
identifying, by the image editing circuit, at least one historical image stored on a communicably coupled storage device, the at last one historical image including the subject in which appears an unflawed feature corresponding to the identified flawed feature in the first image;
selecting, by the image editing circuit, a portion of the at least one historical image in which the unflawed feature appears, the selected portion of the at least one historical image corresponding to the identified portion of the first image; and
replacing, by the image editing circuit, the identified portion of the first image with the selected portion of the at least one historical image to provide a second image in which the flawed feature is absent.

37. The method of claim 36 wherein identifying a portion of the subject having a flawed feature comprises:
causing, by the image editing circuit, a display of the first image on a communicably coupled display device; and
receiving, by the image editing circuit, a user input corresponding to a selected portion of the first image in which the flawed feature appears.

38. The method of claim 36 wherein identifying a portion of the subject having a flawed feature comprises:
causing, by the image editing circuit, a display of the first image on a communicably coupled display device;
autonomously identifying, by the image editing circuit, the portion of the first image that contains the flawed feature; and
receiving, via the user input device, a user input indicative of either: a confirmation of the autonomously selected portion of the first image; or an input corresponding to a user selected portion of the first image that in which the flawed feature appears.

39. The method of claim 36 wherein identifying a portion of the subject having a flawed feature comprises:
identifying, by the image editing circuit, a portion of the first image in which a flawed anatomical feature of an animate object appears.

40. The method of claim 39 wherein identifying, by the image editing circuit, a portion of the first image in which a flawed anatomical feature of an animate object appears comprises:
identifying, by the image editing circuit, a portion of the first image in which a flawed facial feature of a human subject appears.

41. The method of claim 40 wherein identifying at least one historical image stored on a communicably coupled storage device, the at last one historical image including the subject and containing a unflawed feature corresponding to the identified flawed feature in the first image comprises:
autonomously identifying, by the image editing circuit, the at least one historical image via an automated facial recognition of the human subject in the at least one historical image and which corresponds to the uniquely identified human subject appearing in the first image.

42. The method of claim 36 wherein identifying at least one historical image that includes the object and an unflawed feature from a number of historical digital images stored on a communicably coupled storage device comprises:
autonomously scaling, by the image editing circuit, the at least one historical image such that a size of the subject in the at least one historical image corresponds to a size of the subject in the first image.

43. The method of claim 42 wherein identifying at least one historical image that includes the object and an unflawed feature from a number of historical digital images stored on a communicably coupled storage device comprises:
autonomously correcting, by the image editing circuit, the at least one historical image such that at least one of a color, a brightness, or a contrast of the subject in the at least one identified historical image corresponds to at least one of a color, a brightness, or a contrast of the subject in the first image.

44. The method of claim 36 wherein identifying at least one historical image that includes the object and an unflawed feature from a number of historical digital images stored on a communicably coupled storage device comprises:
autonomously altering, by the image editing circuit, a physical parameter of the subject in the at least one identified historical image such that at least one of: a pose of the subject or a rotation of the subject corresponds to at least one of: a pose of the subject or a rotation of the subject in the first image.

45. A storage device containing a machine-readable instruction set that, when executed by a circuit, causes the circuit to provide image editing circuit, the image editing circuit to:
identify a portion a subject appearing in a first image received from a communicably coupled image acquisition device, the identified portion of the subject having at least one flawed feature;
autonomously uniquely identify the subject appearing in the first image;
autonomously identify at least one historical image stored on a communicably coupled storage device, the at last one historical image including the subject with an unflawed feature corresponding to the identified flawed feature in the first image;
autonomously select a portion of the at least one historical image in which the unflawed feature appears, the selected portion of the at least one historical image corresponding to the identified portion of the first image; and
autonomously replace the identified portion of the first image with the selected portion of the at least one historical image to provide a second image in which the flawed feature is absent.

46. The machine-readable instruction set of claim 45 wherein the instructions that cause the image editing circuit to identify a portion a subject appearing in a first image received from a communicably coupled image acquisition device, the identified portion of the subject having at least one flawed feature cause the image editing circuit to:
display the first image on the display device; and
receive a user input from a communicably coupled user input device, the user input including information corresponding to a user-selected portion of the first image containing the flawed feature.

47. The machine-readable instruction set of claim 45 wherein the instructions that cause the image editing circuit to identify a portion a subject appearing in a first image received from a communicably coupled image acquisition device, the identified portion of the subject having at least one flawed feature cause the image editing circuit to:
cause a display of the first image on a communicably coupled display device;
autonomously identify the portion of the first image that contains the flawed feature; and
receive a user input indicative of either: a confirmation of the autonomously selected portion of the first image; or an input corresponding to a user-selected portion of the first image that in which the flawed feature appears.

48. A system that causes a circuit to provide a digital image editing circuit, the system comprising:
a means for identifying a portion a subject appearing in a first image received from a communicably coupled image acquisition device, the identified portion of the subject in which a flawed feature appears;
a means for autonomously uniquely identifying the subject appearing in the first image;
a means for autonomously identifying at least one historical image stored on a communicably coupled storage device, the at last one identified historical image including the subject in which an unflawed feature corresponding to the identified flawed feature in the first image appears;
a means for autonomously selecting a portion of the at least one historical image in which the unflawed feature appears, the selected portion of the at least one historical image corresponding to the identified portion of the first image; and
a means for autonomously replacing the identified portion of the first image with the selected portion of the at least one historical image to provide a second image in which the flawed feature is absent.

49. The system of claim 48 wherein the means for identifying a portion a subject appearing in a first image received from a communicably coupled image acquisition device, the identified portion of the subject having at least one flawed feature comprises:
a means for causing a display of the first image on a communicably coupled display device; and
a means for receiving a user input corresponding to a selected portion of the first image in which the flawed feature appears.

50. The system of claim 48 wherein the means for selecting a portion of the first image received from a communicably coupled digital image source that contains a flawed feature of an object comprises:
a means for causing a display of the first image on a communicably coupled display device;
a means for autonomously identifying the portion of the first image that contains the flawed feature; and
a means for receiving a user input indicative of either: a confirmation of the autonomously selected portion of the first image; or an input corresponding to a user selected portion of the first image that in which the flawed feature appears.
